(19) United States
(12) Patent Application Publication
(10) Pub. No.: US 2006/0046600 A1
(43) Pub. Date: Mar. 2, 2006

(54) Method for manufacturing display panels

(75) Inventors: Yoichi Okumura, Yamanashi-ken (JP); Tasuku Ishibashi, Yamanashi-ken (JP); Takashi Yamada, Yamanashi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/206,065

(22) Filed: Aug. 18, 2005

(30) Foreign Application Priority Data
Aug. 27, 2004 (JP) 2004-247972

(51) Int. Cl. H01J 9/00; H01J 9/24

(52) U.S. Cl. 445/24; 445/14

(57) ABSTRACT

A connective insulating membrane is formed on only the bottom face of the metallic partition wall. The metallic partition wall is positioned in a predetermined position on the substrate with the connective insulating membrane on the bottom face being in contact with the substrate, and a dielectric film is superimposed on the metallic partition wall. With the dielectric film, the metallic partition wall and the back glass substrate thus positioned, a burning process is performed to fuse the connective insulating film with the substrate, whereby the metallic partition wall is secured to the substrate and the metallic partition wall and the exposed faces of the substrate are covered by a dielectric membrane formed of the dielectric film.

### BACKGROUND OF THE INVENTION

1. Field of the Invention

This invention relates to a method of manufacturing display panels having a metallic partition wall.

The present application claims priority from Japanese Application No. 2004-247972, the disclosure of which is incorporated herein by reference.

2. Description of the Related Art

FIG. 1 is a perspective view illustrating the structure of a conventional plasma display panel (hereinafter referred to as “PDP”) having a metallic partition wall.

The PDP in FIG. 1 is structured such that the front glass substrate 1 that is provided on its inner face with a plurality of row electrode pairs (not shown) and the back glass substrate 2 that is provided on its inner face with a plurality of column electrodes (not shown) each extending in a direction at right angles to the row electrode pairs are placed on either side of a discharge space, and a grid-shaped metallic partition wall 3 having the surface covered by an electrical-insulation layer is interposed between the front glass substrate 1 and the back glass substrate 2.

Discharge cells formed in the discharge space in correspondence to the intersections between the row electrode pairs provided on the front glass substrate 1 and the column electrodes provided on the back glass substrate 2 are defined by through holes 3a of the metallic partition wall 3 which configure the spaces forming the discharge cells arranged in matrix form.

Such a conventional PDP is disclosed in Japanese patent publication No. 2741418, for example.

FIGS. 2 and 3 are diagrams illustrating the steps for mounting the metallic partition wall 3 on the back glass substrate 2 in the manufacturing process for the PDP structured as described above.

Before starting the step of mounting the metallic partition wall 3 on the back glass substrate 2, the step of covering the metallic partition wall 3 with an insulating membrane 3A has been performed so that the overall surface of the metallic partition wall 3 is covered by the insulating membrane 3A, and the column electrodes D and the column-electrode protective layer 4 have been formed on the back glass substrate 2.

As shown in FIG. 2, the metallic partition wall 3 with the insulating membrane 3A covering thereon is placed on the column-electrode protective layer 4 overlying the back glass substrate 2 and is positioned in alignment with a predetermined position, and then the burning step is performed.

Through the burning step, as shown in FIG. 3, the insulating membrane 3A covering the metallic partition wall 3 and the column-electrode protective layer 4 on the back glass substrate 2 are fused with each other so as to secure the metallic partition wall 3 in the predetermined position on the back glass substrate 2.

The PDP thus structured benefits from the use of a metal-made partition wall, so that the step of forming the partition wall in the manufacturing process is simplified.

However, for a PDP using the metallic partition wall there is a need to perform the insulation coating treatment on the overall surface of the metallic partition wall prior to the fixing of the metallic partition wall to the back glass substrate as described above. This need entails the problem of increased cost.

Further, as another problem arising in a PDP using such a metallic partition wall, a deformation and/or a warp appears on occasion on the metallic partition wall due to heating when the insulation coating treatment is performed on the metallic partition wall. In this event, the step of correcting such a deformation or warp is additionally required.

A PDP using the metallic partition wall has a further problem: in the burning step, performed for fusing together the column-electrode protective layer on the back glass substrate and the insulating membrane of the metallic partition wall, the metallic partition wall is likely to peel away from the column-electrode protective layer because of the occurrence of a warp or the like on the metallic partition wall.

The foregoing problems associated with the manufacturing arise, not only in a PDP as described above, but also other types of display panels using a metallic partition wall for partitioning the space between the two opposing substrates into unit display spaces.

### SUMMARY OF THE INVENTION

It is a technical object of the present invention to overcome the problems associated with the manufacturing process for display panels using a metallic partition wall as described above.

To attain this object, the present invention provides a method of manufacturing a display panel having a metal-made partition wall partitioning a space between the two opposing substrates into unit display spaces. This method is characterized by the steps of: forming a connective insulating membrane on only the bottom face of the metallic partition wall; positioning the metallic partition wall in a predetermined position on the substrate with the connective insulating membrane on the bottom face being in contact with the substrate; superimposing a film with insulating properties on the metallic partition wall; performing the burning step to fuse the connective insulating membrane with the substrate, whereby the metallic partition wall is secured to the substrate and the metallic partition wall and the exposed faces of the substrate are covered by an insulating membrane formed of the film with the insulating properties.

In the method of manufacturing a display panel according to the best mode for carrying out the present invention, in the manufacturing process for the display panel, the surface of the metallic partition wall and the face of the substrate to which the metallic partition wall is to be attached are covered by an insulating membrane. At this point, for securing the metallic partition wall to the substrate forming part of the panel, the metallic partition wall having a connective insulating membrane pre-formed on its bottom face is positioned in a predetermined position on the substrate with the connective insulating membrane being in contact with the substrate. Further, a film with insulating properties (hereinafter referred to as “insulational film”) is superimposed on the metallic partition wall. At this point, the burning step is performed.

In the method of manufacturing the display panel in the best mode, through the burning step the connective insulating membrane is welded to the substrate, thereby securing the metallic partition wall to the predetermined position on the substrate.

Further, concurrently, the insulational film superimposed on the metallic partition wall is welded to the metallic partition wall and the exposed faces of the substrate to form an insulating membrane, resulting in the covering of the metallic partition wall and the exposed faces of the substrate by the insulating membrane.

As described above, the method of manufacturing the display panel in the best mode solves the foregoing problems: that is, the insulation treatment of the metallic partition wall is simplified as compared with the related art, thereby significantly reducing the costs for the insulation treatment on the metallic partition; there is no chance of a deformation and/or a warp being caused on the metallic partition wall by heat in the insulation treatment of the metallic partition wall as occurring in the conventional method, thereby eliminating the need to perform a step for correcting a deformation and/or a warp and preventing the metallic partition wall from peeling away from the substrate due to the deformation or the warp.

These and other objects and features of the present invention will become more apparent from the following detailed description with reference to the accompanying drawings.

### BRIEF DESCRIPTION OF THE DRAWINGS

FIG. 1 is a schematic diagram illustrating the structure of a display panel in the related art.

FIG. 2 is a diagram illustrating a step in the manufacturing process for the display panel in the related art.

FIG. 3 is a diagram illustrating another step in the manufacturing process for the display panel in the related art.

FIG. 4 is a sectional view illustrating the state of the metallic partition wall in the manufacturing process for the display panel in an embodiment according to the present invention.

FIG. 5 is a sectional view illustrating the state of the back glass substrate in the manufacturing process for the display panel in the embodiment according to the present invention.

FIG. 6 is a diagram illustrating a step in the manufacturing process for the display panel in the embodiment according to the present invention.

FIG. 7 is a diagram illustrating another step in the manufacturing process for the display panel in the embodiment according to the present invention.

### DETAILED DESCRIPTION OF THE PREFERRED EMBODIMENT

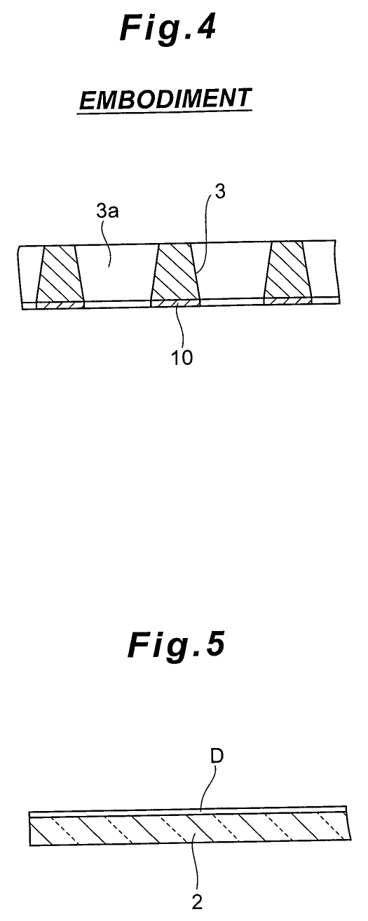

FIGS. 4 to 7 are diagrams illustrating an embodiment of a method of manufacturing a display panel according to the present invention.

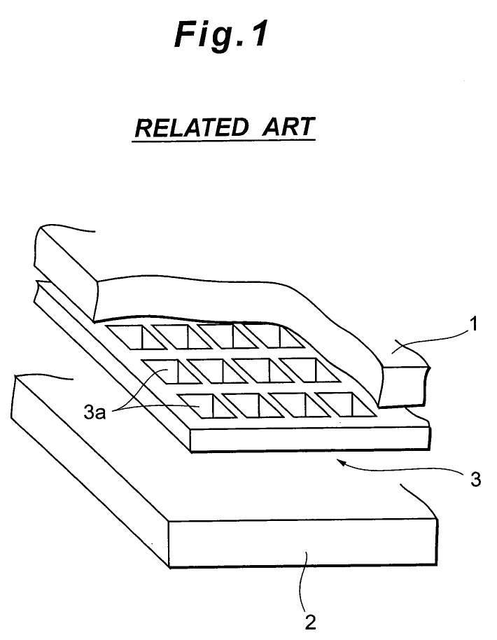

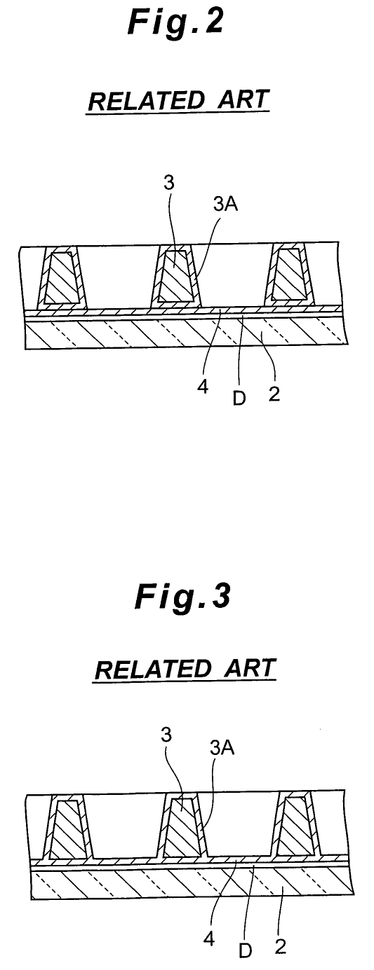

In the following description, the same components as those in the structure of a conventional display panel are designated by the reference numerals used in FIGS. 1 to 3.

In the method for manufacturing the display panel in the embodiment, before performing the step of mounting the metallic partition wall 3 on the back glass substrate 2, as shown in FIG. 4, a connective insulating membrane 10 is formed only on the bottom face (the under face in FIG. 4) of the metallic partition wall 3 to be joined to the back glass substrate 2. The metallic partition wall 3 has through holes 3 arranged in matrix form for defining unit display spaces.

The connective insulating membrane 10 is formed, for example, by bonding a dielectric film onto the bottom face of the metallic partition wall 3.

Further, as shown in FIG. 5, electrodes D are formed in predetermined positions on the back glass substrate 2 by a method such as patterning using the aluminum spattering or photolithography techniques.

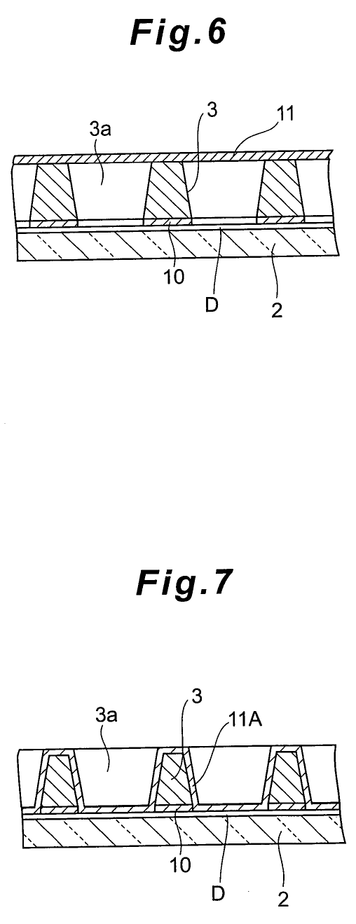

Then, as shown in FIG. 6, the metallic partition wall 3 with the connective insulating membrane 10 formed thereon is placed on the back glass substrate 2 with the electrodes D formed thereon and is positioned in a predetermined position. After that, the dielectric film 11 is superimposed on the metallic partition wall 3. At this point, the burning step is performed at temperatures from 400° C. to 600° C.

Through this burning step, as illustrated in FIG. 7, the connective insulating membrane 10 formed on the bottom face of the metallic partition wall 3 and in contact with the back glass substrate 2 is fused to the back glass substrate 2, whereby the metallic partition wall 3 is secured in the predetermined position on the back glass substrate 2.

Simultaneously with this, the dielectric film 11 placed on the metallic partition wall 3 is softened, and comes into contact with and fused to the surface of the metallic partition wall 3 and the faces of the back glass substrate 2 corresponding to the respective through holes 3a of the metallic partition wall 3.

In this manner, the fusion of the metallic partition wall 3 to the back glass substrate 2 and the formation of the dielectric layer 11A covering the metallic partition wall 3, the back glass substrate 2 and the surfaces of the electrodes D are performed simultaneously.

In the foregoing method of manufacturing the PDP, various problems as described earlier are overcome. The insulation treatment of the metallic partition wall 3 is simplified as compared with the conventional methods, resulting in a significant reduction in the costs for the insulation treatment on the metallic partition 3. Further, there is no chance of a deformation and/or a warp being caused on the metallic partition wall 3 by heat in the insulation treatment of the metallic partition wall 3 as occurring in the conventional method. In consequence, the need to perform a step for correcting a deformation and/or a warp is eliminated and the metallic partition wall is prevented from peeling away from the substrate due to the deformation or the warp.

The terms and description used herein are set forth by way of illustration only and are not meant as limitations. Those skilled in the art will recognize that numerous variations are possible within the spirit and scope of the invention as defined in the following claims.

What is claimed is:

1. A method of manufacturing a display panel having a metal-made partition wall partitioning a space between two opposing substrates into unit display spaces, comprising the steps of:
forming a connective insulating membrane on only a bottom face of the metallic partition wall;
positioning the metallic partition wall in a predetermined position on the substrate with the connective insulating membrane on the bottom face being in contact with the substrate, and superimposing a film with insulating properties on the metallic partition wall; and
with the film with the insulating properties, the metallic partition wall and the substrate thus positioned, performing a burning process to fuse the connective insulating membrane with the substrate, whereby the metallic partition wall is secured to the substrate and the metallic partition wall and the exposed faces of the substrate are covered by an insulating membrane formed of the film with the insulating properties.

2. A method of manufacturing a display panel according to claim 1, wherein the connective insulating membrane is formed by affixing a dielectric film to the bottom face of the metallic partition wall.

3. A method of manufacturing a display panel according to claim 1, wherein the film with the insulating properties is a dielectric film.

4. A method of manufacturing a display panel according to claim 1, wherein the metallic partition wall has through holes configuring unit display spaces arranged in matrix form.

5. A method of manufacturing a display panel according to claim 1, wherein the burning process is performed at temperatures ranging from 400° C. to 600° C.

6. A method of manufacturing a display panel according to claim 1, further comprising the step of forming electrodes on the substrate before the step of forming a connective insulating membrane on the bottom face of the metallic partition wall.
